(19) United States
(12) Patent Application Publication
(10) Pub. No.: US 2005/0219385 A1
(43) Pub. Date: Oct. 6, 2005

(54) Device for preventing red eye, program therefor, and recording medium storing the program

(75) Inventor: Kensuke Terakawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/089,517

(22) Filed: Mar. 25, 2005

(30) Foreign Application Priority Data
Mar. 25, 2004 (JP) 089640/2004
Mar. 23, 2005 (JP) 083917/2005

(51) Int. Cl. H04N 5/262

(52) U.S. Cl. 348/239

(57) ABSTRACT

Occurrence of red eye at the time of flash photography can be prevented with a high probability according to tendency of red-eye occurrence caused by various factors and according to a difference of the tendency among people. A memory in a red-eye prevention device stores reference data for red-eye prevention defining photography conditions for each person. An identification unit identifies a person subjected to flash photography by a camera. In the case where the identification unit cannot identify the person, a registration unit registers an additional person and initial photography conditions with the memory as a part of the reference data. The identification unit identifies the person as the additional person, and a photography condition selection unit selects actual photography conditions for red-eye prevention for flash photography by the camera of the person identified by the identification unit, based on the reference data in the memory.

### BACKGROUND OF THE INVENTION

1. Field of the Invention

The present invention relates to a device for preventing red eye, a program therefor, and a recording medium storing the program. More specifically, the present invention relates to a red-eye prevention device installable in a camera by being built in or by connection or the like, to a red-eye prevention program for causing a computer installable in a camera by being built in or by connection or the like to carry out red-eye prevention, and to a computer-readable recording medium storing the red-eye prevention program.

2. Description of the Related Art

The red-eye phenomenon (hereinafter simply referred to as red eye) caused by flash photography of people damages natural appearance of a photograph, which is not desirable. Therefore, a technique for preventing red eye has been conventionally used, by shrinking pupils of people's eyes through pre-flash before photography, for example.

In the red-eye prevention technique using pre-flash, tendency of red-eye occurrence varies, depending on a photography situation. Therefore, a method of adjusting an amount of light of pre-flash according to a photography situation has also been proposed. For example, a method has been described in Japanese Unexamined Patent Publication No. 2001-174884, for determining an optimal amount of light of pre-flash in order to prevent red eye according to a distance to a person to be photographed. Furthermore, a method has been described in Japanese Unexamined Patent publication No. 2004-069819 for determining an amount of light of pre-flash in order to prevent red eye while reducing power consumption of a flash according to lightness of a photography environment.

However, tendency of red-eye occurrence changes not only by a photography situation such as a photography distance and lightness in a photography environment but also a target person to be photographed. Therefore, even if a setting of a flash is optimized according to a photography situation, red eye cannot be prevented in photography of a person while it can be prevented in photography of another person. Furthermore, in an image of a group photo, red eye sometimes occurs only on a part of people while it can be prevented regarding the remaining people.

In addition, since the tendency of red-eye occurrence is determined by a combination of a plurality of factors such as a photography distance, lightness in a photography environment, and a target person to be photographed, prevention of red eye with a high probability is difficult by using only one fixed criterion.

### SUMMARY OF THE INVENTION

The present invention has been conceived based on consideration of the above circumstances. An object of the present invention is therefore to provide a red-eye prevention device, a red-eye prevention program and a recording medium storing the program for preventing occurrence of red eye according to a difference in tendency of red-eye occurrence depending on a person and/or a difference in tendency of red-eye occurrence caused by various factors.

More specifically, a first red-eye prevention device of the present invention is a device installable in a camera, and the device comprises:
registration means for registering a plurality of persons and photography conditions for the respective persons as reference data for red-eye prevention;
identification means for identifying a target person to be subjected to flash photography by the camera; and
photography condition selection means for selecting actual photography conditions for preventing red eye at the time of actual flash photography of the target person identified by the identification means with the camera, based on the reference data.

The “identifying a target person” is not limited to identifying an individual person, but means to include classifying characteristics of a target person or group of persons. That is, classifying the characteristics of a person does not mean an individual person, but means more broadly various types of persons such as race, family, age, gender, degree of possibility of presenting red-eye. Further, the person should not be limited here to a human being, but should be understood to include animals such as dogs, cats, rabbits, etc. which are likely to present red-eyes.

The photography conditions in the present invention refer to conditions satisfied by settings of the camera. The actual photography conditions refer to photography conditions used at the time of actual photography by the camera, which include the amount of light not only of pre-flash, but also of strobo flash. Further, the selection of actual photography conditions to avoid red-eye is not limited to controlling the amount of light, but includes turning off the strobo in accordance with the target person or environment and increase sensitivity or increasing the gain. The settings include a setting of a flash, regardless of whether the flash is unified with the camera or separated from the camera.

The identification means may receive manual identification of the target person to be photographed, from an operator. Alternatively, data representing a characteristic of the face of the target person may be obtained in advance so that the target person can be identified automatically by comparison with data representing a characteristic of the face of each of the persons already registered by the registration means, for example.

The registration means in the present invention may receive manual registration of the persons and the photography conditions therefor. Alternatively, the persons may be registered manually while default photography conditions or actual photography conditions used for another person may be registered as initial photography conditions to be updated later, for example. In the case where the identification means automatically identifies the target person to be photographed, the identification means may identify a person who was not identified as one of the registered persons as an additional person so that the registration means automatically registers the additional person. If there are a plurality of additional persons, the registration means may register only a part of the additional persons selected by an operator. In these cases, the default photography conditions or the actual photography conditions used for another person may be registered as the photography conditions for the additional person or persons to be updated later, for example.

The first red-eye prevention device of the present invention may further comprise display means for displaying all or a part of the actual photography conditions for confirmation by an operator.

Furthermore, the first red-eye prevention device of the present invention may further comprise setting change means for changing a setting of the camera so as to satisfy all or a part of the actual photography conditions.

Moreover, the first red-eye prevention device of the present invention may further comprise:
red-eye detection means for detecting whether or not red eye is observed regarding the target person in a photograph image generated by the actual flash photography by the camera using the actual photography conditions; and
update means for updating the photography conditions for the target person in the reference data, based on presence or absence of red eye and the actual photography conditions. In this case, at the time of registration of the additional person, the registration means may register the default photography conditions determined in advance as the initial photography conditions therefor.

The first red-eye prevention device of the present invention may further comprise photography situation detection means for detecting a distance between the target person and the camera and/or lightness of a photography environment so that the photography conditions defined by the reference data for each of the persons can be photography conditions defined according to the distance between the camera and the corresponding person and/or the lightness of the photography environment. In this case, the first red-eye prevention device of the present invention may further comprise red-eye detection means for detecting whether or not red eye is observed regarding the target person in the photograph image generated by the actual flash photography of the target person by the camera using the actual photography conditions, and update means for updating the photography conditions for the target person in the reference data, based on presence or absence of red eye, the distance and/or the lightness detected by the photography situation detection means, and the actual photography conditions. At the time of registration of the additional person, the registration means may register the default photography conditions determined in advance as the initial photography conditions therefor.

In the first red-eye prevention device of the present invention, the identification means may be able to identify a plurality of target persons at the same time while the photography condition selection means can select the actual photography conditions for prevention of red eye for all the target persons identified by the identification means, based on the reference data.

In the first red-eye prevention device of the present invention, the photography conditions may include a distance between a lens of the camera and the flash.

Furthermore, in the first red-eye prevention device of the present invention, the photography conditions may include a condition representing an amount of light in pre-flash.

The condition representing the amount of light in pre-flash may be a condition representing the amount of light itself in pre-flash or a condition representing the amount of light indirectly, such as duration or intensity of pre-flash, for example.

A second red-eye prevention device of the present invention is a device installable in a camera, and the device comprises:
red-eye detection means for detecting whether or not red eye is observed in a photograph image obtained by flash photography by the camera using predetermined actual photography conditions; and
photography condition update means for determining next-time actual photography conditions for preventing occurrence of red eye in flash photography next time, based on presence or absence of red eye and the predetermined actual photography conditions.

In the present invention, determining the next-time actual photography conditions based on presence or absence of red eye and the predetermined actual photography conditions refers to not only determining the next-time actual photography conditions according to presence or absence of red eye and the predetermined actual photography conditions used in the immediately preceding flash photography, but also determining the next-time actual photography conditions according to presence or absence of red eye and the predetermined actual photography conditions used in the immediately preceding flash photography and in flash photography prior thereto.

The second red-eye prevention device of the present invention may further comprise display means for displaying all or a part of the next-time actual photography conditions for confirmation by an operator.

Furthermore, the second red-eye prevention device of the present invention may further comprise setting change means for changing a setting of the camera so as to satisfy all or a part of the next-time actual photography conditions.

In the second red-eye prevention device of the present invention, the predetermined actual photography conditions and the next-time actual photography conditions may include a distance between an imaging lens and a flash of the camera.

Furthermore, in the second red-eye prevention device of the present invention, the predetermined actual photography conditions and the next-time actual photography conditions may include a condition representing an amount of light in pre-flash.

A first red-eye prevention program of the present invention is a program for causing a computer installable in a camera to function as:
registration means for registering a plurality of persons and photography conditions for the respective persons as reference data for red-eye prevention;
identification means for identifying a target person to be subjected to flash photography by the camera; and
photography condition selection means for selecting actual photography conditions for preventing red eye at the time of actual flash photography of the target person identified by the identification means with the camera, based on the reference data. A first recording medium of the present invention is a computer-readable recording medium storing the first red-eye prevention program.

A second red-eye prevention program of the present is a program for causing a computer installable in a camera to function as:
red-eye detection means for detecting whether or not red eye is observed in a photograph image obtained by flash photography by the camera using predetermined actual photography conditions; and
photography condition update means for determining next-time actual photography conditions for preventing occurrence of red eye in flash photography next time, based on presence or absence of red eye and the predetermined actual photography conditions. A second recording medium of the present invention is a computer-readable recording medium storing the second red-eye prevention program.

The first red-eye prevention device, the first program, and the first recording medium of the present invention select the actual photography conditions for flash photography of the target person identified by the identification means, based on the reference data for red-eye prevention defining the persons and the photography conditions therefor. Therefore, the actual photography conditions can be selected optimally for prevention of red eye regarding the target person, depending on a difference in tendency of red-eye occurrence among the persons.

In the case where the display means is used in the first red-eye prevention device, the first program, and the first recording medium of the present invention in order to display all or a part of the actual photography conditions selected by the photography condition selection means for confirmation by an operator, the operator can change the setting of the camera through the confirmation of all or the part of the actual photography conditions displayed on the display means. Furthermore, if the setting change means is used for changing the setting of the camera so as to satisfy all or a part of the actual photography conditions selected by the photography condition selection means, the selection of the actual photography conditions and the camera setting change can be carried out serially and automatically.

In the case where the first red-eye prevention device, the first program, and the first recording medium of the present invention use the red-eye detection means for detecting whether or not red eye is observed on the target person in the photograph image obtained by flash photography and the update means for updating a part of the reference data defining the photography conditions for the target person according to presence or absence of red eye and the actual photography conditions, a probability of red-eye prevention can be improved in a stepwise manner for each of the persons, and the actual photography conditions can be found for red-eye prevention demanding less burden on the target person and the camera in a preventable range of red-eye occurrence in an actual photography situation, by feeding back information on tendency of red-eye occurrence regarding each of the persons in the actual photography situation to the reference data.

In the case where the first red-eye prevention device, the first program, and the first recording medium of the present invention use photography situation detection means for detecting the distance between the camera and the target person and/or the lightness of the photography environment, if the photography conditions defined by the reference data for each of the persons are photography conditions defined according to the distance between the corresponding person and the camera and/or the lightness of the photography environment, the actual photography conditions can be selected optimally for prevention of red eye in the photography distance and the lightness for the target person, according to a difference in tendency of red-eye occurrence for the target person and a difference in tendency of red-eye occurrence in the photography distance and the lightness. In this case, if the first red-eye prevention device, the first program, and the first recording medium of the present invention use the red-eye detection means for detecting whether or not red eye is observed in the target person in the photograph image obtained by flash photography and the update means for updating the part of the reference data defining the photography conditions for the target person according to presence or absence of red eye, the photography distance and/or the lightness detected by the photography situation detection means as well as the actual photography conditions, the probability of red-eye prevention can be improved in a stepwise manner regarding each of the persons, the photography distance, and the lightness, and the actual photography conditions can be found for red-eye prevention demanding less burden on the target person and the camera in a preventable range of red-eye occurrence in an actual photography situation, by feeding back information on tendency of red-eye occurrence regarding each of the persons in the actual photography situation to the reference data.

Furthermore, in the first red-eye prevention device, the first program, and the first recording medium of the present invention, if the identification means can identify a plurality of persons and the photography condition selection means can select the actual photography conditions for prevention of red eye for all the persons identified by the identification means, prevention of red-eye occurrence can be realized for all the persons in a group photo.

The second red-eye prevention device, the second program, and the second recording medium of the present invention detect whether or not red eye is observed in the photograph image obtained by flash photography by the camera using the predetermined actual photography conditions, and determine the next-time actual photography conditions for prevention of red eye in flash photography next time, based on presence or absence of red eye and the predetermined actual photography conditions. Therefore, according to tendency of red-eye occurrence caused by a combination of various factors in actual photography, the probability of red-eye prevention can be improved in a stepwise manner while the actual photography conditions can be found for red-eye prevention demanding less burden on the target person and the camera in a preventable range of red-eye occurrence in an actual photography situation.

In the case where the second red-eye prevention device, the second program, and the second recording medium of the present invention use the display means for displaying all or a part of the next-time actual photography conditions determined by the photography condition update means for confirmation by an operator, the operator can change the setting of the camera by confirming all or the part of the next-time actual photography conditions displayed on the display means. Furthermore, in the case where the setting change means is used for changing the setting of the camera so as to satisfy all or a part of the next-time actual photography conditions determined by the photography condition update means, the selection of the next-time actual photography conditions and the camera setting change can be carried out serially and automatically.

Note that the program of the present invention may be provided being recorded on a computer readable medium. Those who are skilled in the art would know that computer readable media are not limited to any specific type of device, and include, but are not limited to: CD's, RAM's ROM's, hard disks, magnetic tapes, and internet downloads, in which computer instructions can be stored and/or transmitted. Transmission of the computer instructions through a network or through wireless transmission means is also within the scope of this invention. Additionally, the computer instructions include, but are not limited to: source, object, and executable code, and can be in any language, including higher level languages, assembly language, and machine language.

### BRIEF DESCRIPTION OF THE DRAWINGS

FIG. 1 is a block diagram showing the configuration of a red-eye prevention device of a first embodiment of the present invention;

FIG. 2 is a flow chart showing a procedure carried out by the red-eye prevention device and a camera shown in FIG. 1;

FIGS. 3A to 3E show how reference data are changed when the red-eye prevention device shown in FIG. 1 is used;

FIGS. 4A and 4B show an example of a sample image group learned in advance for red-eye detection;

FIGS. 5A to 5C show an example of learning processing simplified as processing in a two-dimensional characteristic quantity space to find reference data for red-eye detection;

FIG. 6 is a flow chart showing a procedure for red-eye detection carried out by a red-eye detection unit in the red-eye prevention device shown in FIG. 1;

FIG. 7 is a block diagram showing the configuration of a red-eye prevention device of a second embodiment of the present invention; and

FIG. 8 is a flow chart showing a procedure carried out by the red-eye prevention device and a camera shown in FIG. 7.

### DESCRIPTION OF THE PREFERRED EMBODIMENTS

Hereinafter, embodiments of the present invention will be described in detail with reference to the accompanying drawings.

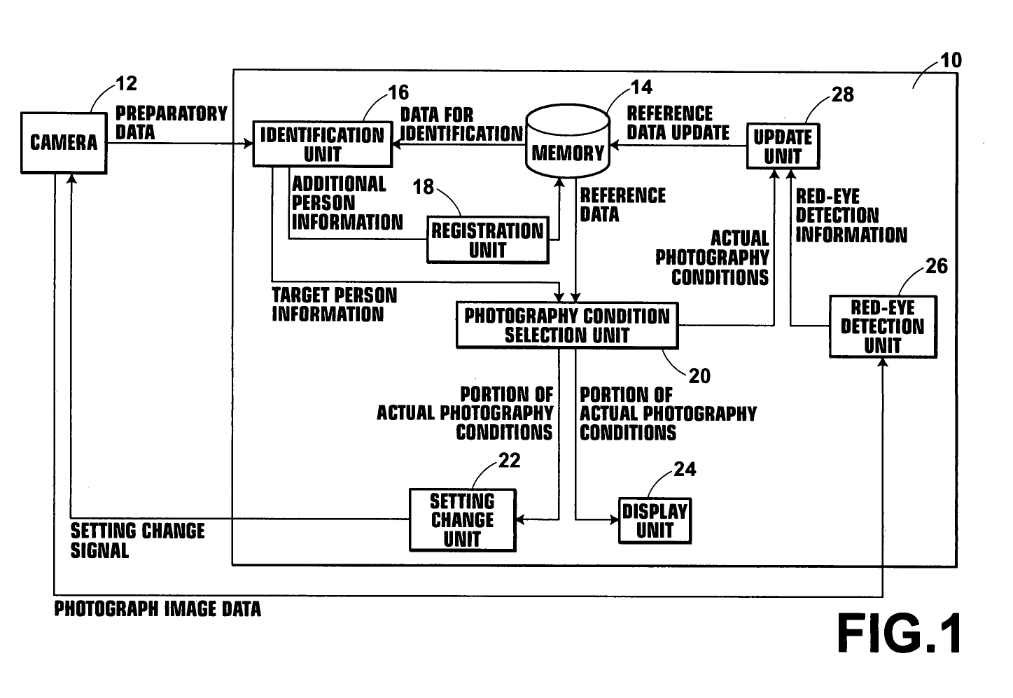

FIG. 1 is a block diagram showing a red-eye prevention device 10 of a first embodiment of the present invention. The red-eye prevention device 10 is installed in a camera 12 by being connected thereto. As shown in FIG. 1, the red-eye prevention device 10 comprises a memory 14, an identification unit 16, a registration unit 18, a photography condition selection unit 20, a setting change unit 22, a display unit 24, a red-eye detection unit 26, and an update unit 28. The memory 14 is used to store data for identification and reference data for red-eye prevention that will be described later. However, in an initial state of the memory 14, only a storage space is available but no data have been stored therein.

The camera 12 is a digital camera that can adjust a distance between the camera and a flash by an extendable arm.

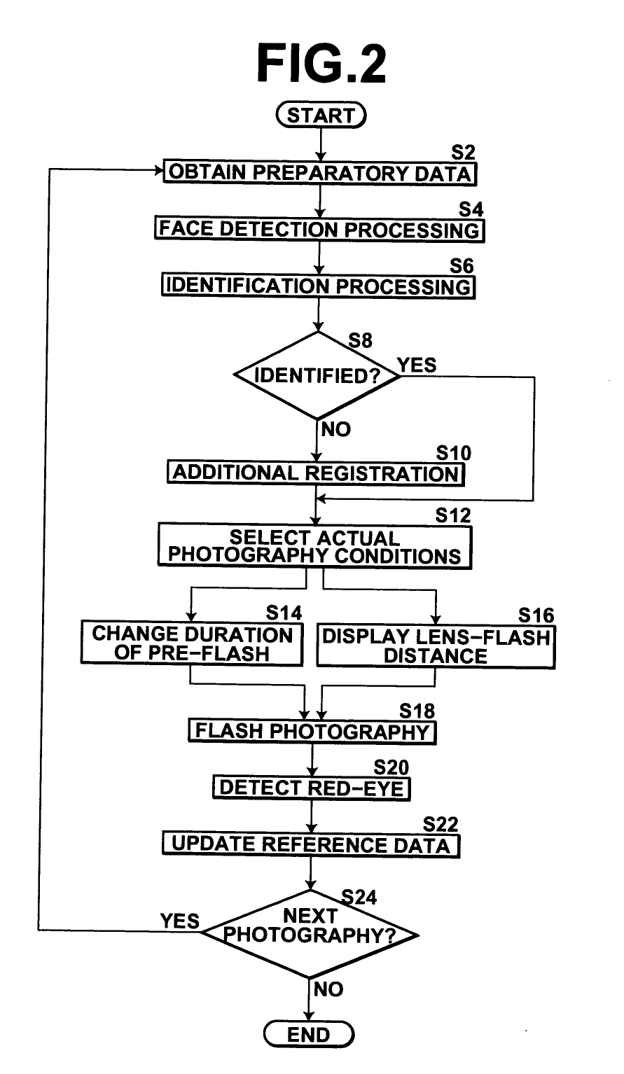

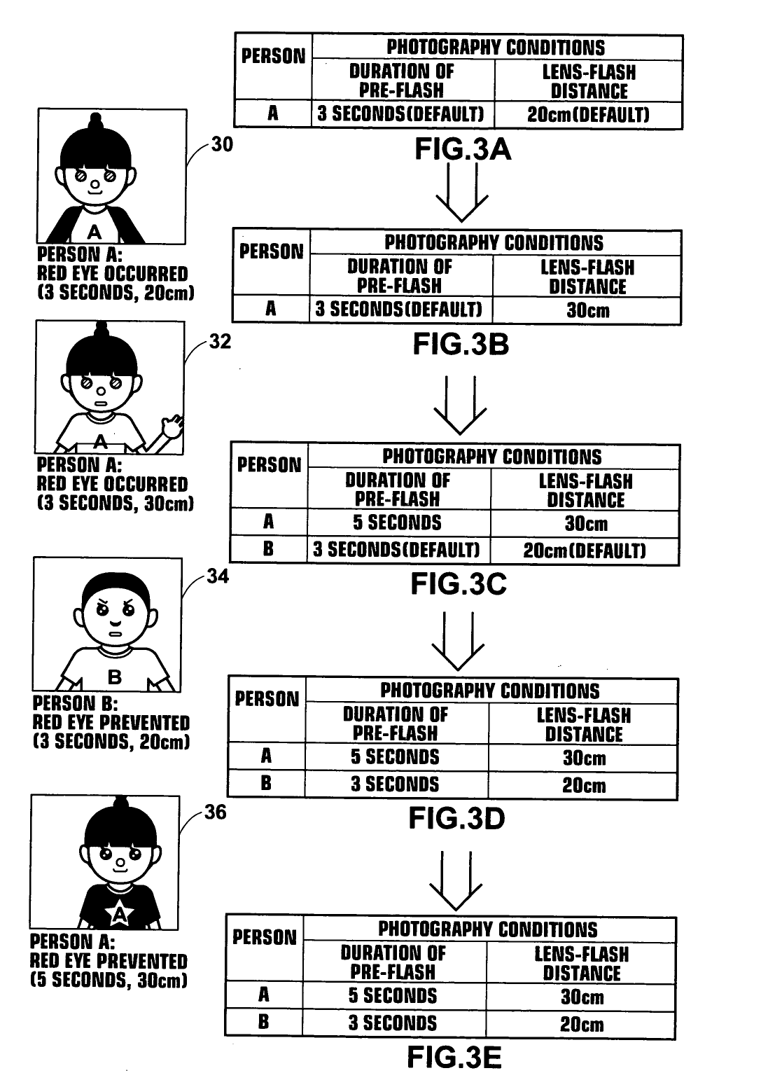

Hereinafter, a procedure of flash photography including red-eye prevention processing carried out by the camera 12 and the red-eye prevention device 10 will be described with reference to a flow chart in FIG. 2 and diagrams in FIGS. 3A to 3E.

At Step S2 in FIG. 2, the camera 12 is set to face a target that is going to be photographed, prior to actual flash photography. Image data representing the target are then obtained as preparatory data, and sent to the identification unit 16.

At Step S4, the identification unit 16 carries out processing for detecting an area corresponding to a human face (hereinafter referred to as a face area) included in the image represented by the preparatory data. In order to carry out the processing of face detection, the identification unit 16 has criteria data representing characteristics of a human face. Any format and any procedure can be used respectively for the criteria data and the face detection processing. In this embodiment, the face detection processing is carried out with use of the criteria data obtained through learning in advance a sample image group comprising sample images representing images of face areas and sample images not representing images of face areas. In order to learn the characteristics of face areas in a range of almost the same proportion to a size of outline of a face, the sample images representing the images of face areas in a standardized range are used. The sample images have the same size. To learn the sample image group, each of the sample images is firstly subjected to wavelet transform in this embodiment, and pairs of wavelet coefficients are used as characteristic quantities for the corresponding sample image. Thereafter, learning processing adopting a method known as boosting is carried out and the criteria data are found in the form of a function. The learning processing using boosting and the detection processing using the criteria data found through the learning will be described later in detail in relation to red-eye detection processing. Although not shown in the flow chart in FIG. 2, in the case where no face area has been detected at Step S4, it is judged that the target to be photographed includes no people, and red eye will not occur. Therefore, the procedure from Step S6 to Step S22 is not carried out, and the procedure goes to Step S24 after flash photography using default photography conditions.

At Step S6, the identification unit 16 carries out identification processing for examining whether characteristics of the face area detected at Step S4 agree with characteristics of any one of people represented by the data for identification that have been registered with the memory 14 by the registration unit 18. The identification processing may adopt any method. For example, a method generally known as “eigenface method” or a method using “Hidden Markov Method” (see Ara V. Nefian et al, “Face Recognition Using an Embedded HMM”, IEEE Proc. International Conference on Acoustics, Speech, and Signal Processing, pp. 3553-3556, 1999) may be used.

At Step S8, whether or not identification has been confirmed at Step S6 is judged. As has been described above, the memory 14 only has the storage space and does not store any identification data at Step S6 carried out for the first time. Therefore, identification cannot be confirmed. Consequently, a result at the following Step S8 is negative, and the procedure goes to Step S10.

At Step S10, the identification unit 16 sends the data representing the characteristics of the face area of a person as the target who has not been identified to the registration unit 18 as data for an additional person. The registration unit 18 registers the data with the memory 14 as a part of the data for identification, and gives an identification label to the additional person. The registration unit 18 pairs the identification label with the default photography conditions as predetermined initial photography conditions, and registers the pair with the memory 14 as a part of the reference data for red-eye prevention. The data in the form of a reference table shown in FIG. 3A represent an example of the reference data stored in the memory 14 at the time of completion of Step S10 for the first time. In the reference data, a person labeled as A is registered with the memory 14 by being paired with the default photography conditions representing 3-second pre-flash by the flash of the camera 12 and 20-cm distance between a lens and the flash of the camera 12 (hereinafter simply referred to as the lens-flash distance). Generally speaking, the longer the duration of pre-flash and the lens-flash distance (that is, the less the light of flash reflected by pupils comes into the lens), the less red eye occurs. However, if the duration of pre-flash is too long, it becomes harder for the target person to take the timing of photography. Therefore, the person is more burdened. If the lens-flash distance is too long, lighting is not sufficient and undesirable shadow tends to appear. Therefore, in the default photography conditions, the duration of pre-flash and the lens-flash distance are comparatively short to a degree that red eye can be prevented thereby unless red eye especially tends to occur on the target person.

At Step S12 in FIG. 2, the photography condition selection unit 20 refers to the reference data in the memory 14 according to information on the target person from the identification unit 16, and selects actual photography conditions for flash photography using the flash. In this example, the photography condition selection unit 20 obtains from the identification unit 16 the information that the target person is the person A registered as the additional person at the immediately preceding Step S10, and selects the conditions defined as the photography conditions for the person A in the reference data shown in FIG. 3A, that is, the 3-second duration of pre-flash and the 20 cm distance between the lens and the flash, as the actual photography conditions.

At Step S14, the condition representing the 3-second duration of pre-flash is sent from the photography condition selection unit 20 to the setting change unit 22 as a part of the actual photography conditions selected at Step S12. The setting change unit 22 sends to the camera 12 a setting change signal for setting the duration of pre-flash to 3 seconds. In addition, the condition representing the 20 cm lens-flash distance is sent from the photography condition selection unit 20 to the display unit 24 at Step S16. The condition is displayed on the display unit 24 for confirmation by an operator of the camera 12. For this display, the display unit 24 may be connected to a liquid crystal display monitor of the camera 12 so that a message “Set the lens-flash distance to 20 cm” can be displayed in superposition on an image displayed in the monitor, for example. The operator confirms the message, and adjusts the arm connecting the camera and the flash so that the distance becomes 20 cm prior to actual flash photography.

At Step S18, the camera 12 carries out flash photography by using the actual photography conditions that have been set. Photograph image data obtained by the photography are stored in a memory in the camera 12, and sent to the red-eye detection unit 26 of the red-eye prevention device 10.

At Step S20, the red-eye detection unit 26 detects whether red eye is observed in the image represented by the photograph image data sent from the camera 12.

Assume that the photograph image obtained at Step S18 carried out this time is an image 30 in FIG. 3 and the red-eye detection unit 26 has detected occurrence of red eye. At Step S22, the update unit 28 changes the photography conditions for the target person A in the reference data stored in the memory 14 to photography conditions that tend to cause less red eye. In this case, the update unit 28 increases the lens-flash distance by 10 cm (that is, to 30 cm), and changes the reference data as shown in FIG. 3B.

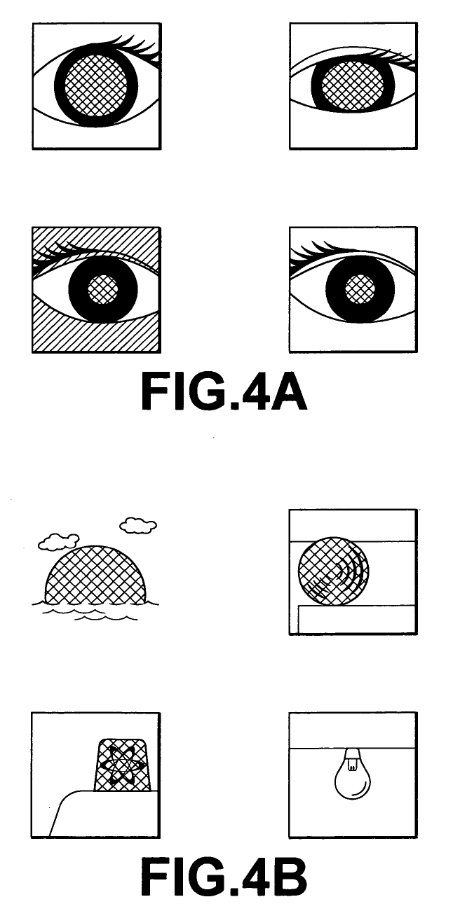

The red-eye detection processing carried out by the red-eye detection unit 26 at Step S20 and learning processing carried out therefor in advance will be described next with reference to FIGS. 4 to 6.

The red-eye detection unit 26 in this embodiment has the reference data for the red-eye detection processing obtained by learning in advance a sample image group shown in FIGS. 4A and 4B. The sample image group comprises sample images representing images of eye areas (hereinafter referred to as positive sample images) wherein red eye is observed (hereinafter referred to as red-eye areas) and sample images not representing red-eye areas (hereinafter referred to as negative sample images). Each of the positive sample images is an image in a standardized range as shown in FIG. 4A so that characteristics of eye areas in almost the same range including red eyes can be learned. The negative sample images may include images of various kinds other than red-eye areas. Alternatively, the negative sample images may include images having characteristics which may lead to erroneous judgment as a red-eye area, such as sunset or an enlargement of a red lamp as shown in FIG. 4B. Each of the sample images has the same size.

The learning processing regarding the sample image group may adopt any method, and the reference data to be generated may take any form such as the reference table. In this embodiment, the reference data are generated in the form of a function according to learning processing using a method known as boosting. In typical boosting, characteristic quantities, that is, parameters representing characteristics are extracted from a first combination of sample data comprising a part of a sample data group to be learned, and plotted in a characteristic quantity space. A first comparatively simple curved surface or the like is defined in the characteristic quantity space for most preferably separating plotted points corresponding to data representing a specific feature from plotted points corresponding to data not representing the specific feature. A second combination of sample data that cannot be classified preferably by the first curved surface or the like is selected, and a second curved surface or the like is defined for most preferably classifying plotted points for the second combination. This procedure is repeated for learning. Finally, an optimal curved surface or an optimal function is then determined for dividing the characteristic quantity space according to majority or the like, by using the curved surfaces defined in the series of procedures.

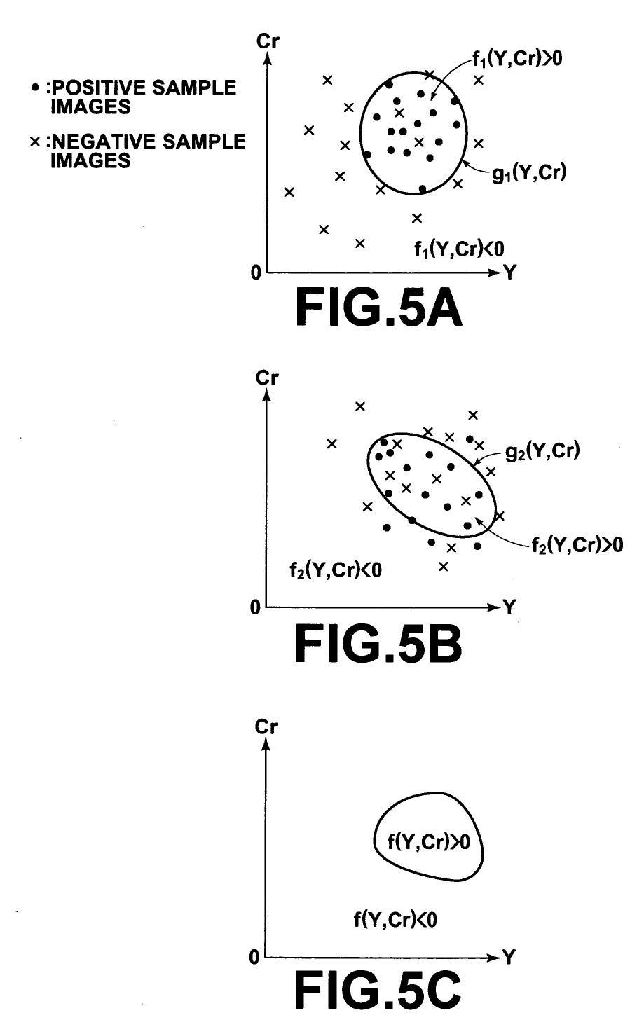

In this embodiment, an average brightness Y and average color differences Cr and Cb are extracted as the characteristic quantities from each of the sample images shown in FIGS. 4A and 4B, and plotted in a YCC color space. A function f(Y, Cr, Cb) is found as the reference data for defining whether each of the plotted points is a point corresponding to an image of red-eye area or to an image not representing a red-eye area. For the sake of simpler explanation, the method for learning will be described with reference to FIGS. 5A to 5C wherein the YCC color space is simplified to a two-dimensional Y—Cr plane.

Firstly, N (where N is a natural number) of the positive sample images and N of the negative sample images are selected randomly from the sample image group. The average brightness Y and the average color difference Cr are then extracted from each of the sample images to be plotted in the Y—Cr plane as shown in FIG. 5A. Thereafter, a quadratic curve g₁(Y,Cr) is defined for most preferably classify the plotted points into points corresponding to the positive sample images and points corresponding to the negative sample images. A function f₁(Y,Cr) is defined as a function taking a positive value in an area wherein the plotted points corresponding to the positive sample images divided by the quadratic curve g₁(Y,Cr) are highly likely to be included while taking a negative value in an area wherein the plotted points corresponding to the negative sample images are highly likely to be included. The absolute value of the function f₁(Y,Cr) at each of the points in the Y—Cr plane is defined by the distance between the corresponding point and the quadratic curve g₁(Y,Cr), for example. The quadratic curve g₁(Y, Cr) and the function f₁(Y,Cr) are defined so as to cause an evaluation function below to become minimal:

Equation (1)

where Yᵢ and Crᵢ represent coordinates of the plotted point corresponding to each of the sample images, while yᵢ is a parameter taking +1 for the positive sample images but −1 for the negative sample images.

Another N of the positive sample images and another N of the negative sample images are selected from the sample image group. The average brightness Y and the average color difference Cr are extracted from each of the selected sample images and plotted in the Y—Cr plane as shown in FIG. 5B. The sample images may be selected randomly. Alternatively, in order to learn with emphasis the sample images whose classification was not carried out with accuracy by the function f₁(Y,Cr), the sample images whose classification result by the function f₁(Y,Cr) did not show a higher correct classification rate than a predetermined threshold value may be selected. A quadratic curve g₂(Y,Cr) and a function f₂(Y,Cr) are also defined as shown in FIG. 5B in the same manner, for plotted points of the newly selected sample images.

If a function f(Y,Cr) is defined as follows:

Equation (2)

current distribution of positive and negative values of the function f(Y, Cr), that is, the values of f₁(Y,Cr)+f₂(Y,Cr) is as shown in FIG. 5C. Thereafter, another N of the positive sample images and another N of the negative sample images are further selected serially from the sample image group, and the function f(Y,Cr) is updated by serially finding functions f₃(Y,Cr), f₄(Y,Cr) and so on in the same manner until the correct classification rate by the function f(Y, Cr) for the sample image group converges with a predetermined minute range of improvement thereof.

The function f(Y,Cr) determined finally in the above manner is used as the reference data for the red-eye detection unit 26. If the value of the function f(Y,Cr) is positive for the average brightness Y and the average color difference Cr extracted from an area in a digital photograph image, the area can be detected as a red-eye area. If the value is negative, the area is not judged to be a red-eye area. The explanation using FIGS. 5A to 5C is simplified in the two-dimensional space. However, as has been described above, the actual reference data found and stored in this embodiment for the red-eye detection unit 26 are the function f(Y,Cr,Cb) defining whether each of points in the YCC color space corresponds to an image of a red-eye area or an image not representing a red-eye area.

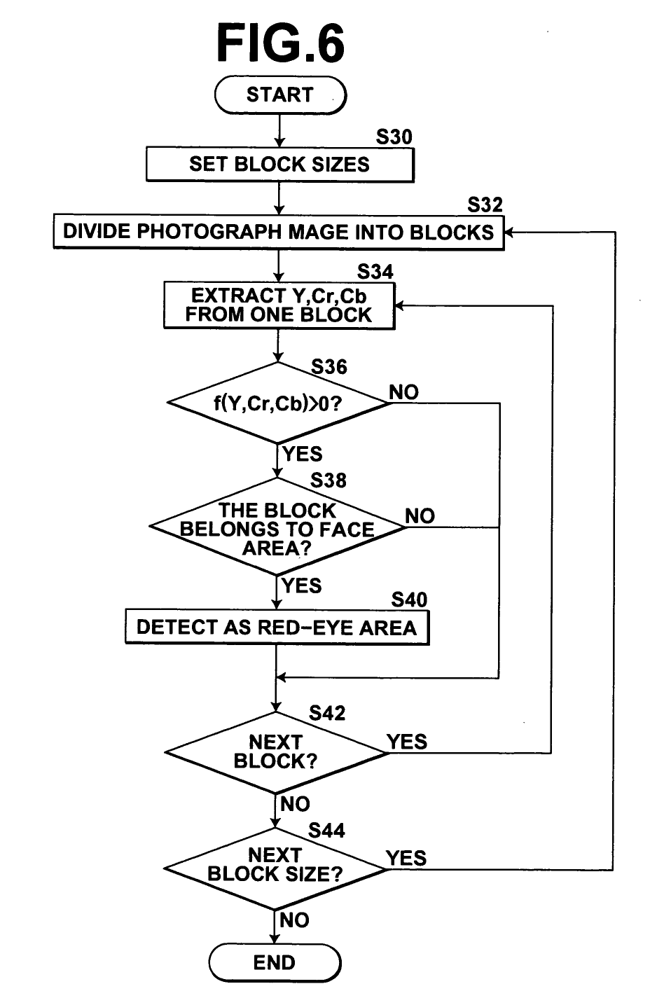

The red-eye detection unit 26 detects whether or not red eye is observed in the photograph image obtained by flash photography, according to a flow chart shown in FIG. 6.

At Step S30, a plurality of block sizes (such as 4×4 pixels, 8×8 pixels, and 16×16 pixels) are defined for dividing the photograph image obtained by flash photography by the camera 12 into blocks. Although the reference data for red-eye detection in this embodiment have been found by learning the sample image group including the positive sample images that have been standardized as shown in FIG. 4A, a size of a person and a size of a red-eye area actually vary from image to image. Therefore, the block sizes are applied for extracting the characteristics of eye areas in almost the same range as the positive sample images.

At Step S32, the red-eye detection unit 26 divides the photograph image into the blocks by using one of the block sizes determined at Step S30.

At Step S34, the red-eye detection unit 26 extracts the average brightness Y and the average color differences Cr and Cb as the characteristic quantities from one of the blocks obtained at Step S32.

At Step S36, the red-eye detection unit 26 judges whether the value of the function f(Y,Cr,Cb) corresponding to the values of Y, Cr, and Cb extracted at Step S34 is positive or negative. If the value is positive, the red-eye detection unit 26 judges at Step S38 whether or not the current block overlaps the face area detected by the identification unit 16 at Step S4 in the flow chart shown in FIG. 2. If the block overlaps, the red-eye detection unit 26 detects the current block as a red-eye area at Step S40, and the procedure goes to Step S42. In the case where the value of the function f(Y,Cr,Cb) is negative or in the case where the current block does not overlap the face area although the value of the function is positive, the current block is not judged to be a red-eye area, and the procedure goes to Step S42 without detection of a red-eye area.

At Step S42, judgment is made as to whether another one of the blocks needs to be examined. If there is another one of the blocks that has not been examined, the procedure returns to Step S34 in FIG. 6. When all the blocks in the current block size have been examined for judgment of a red-eye area, the procedure goes to Step S44 in FIG. 6 whereat judgment is made as to whether another one of the block sizes is available. If there is any one of the block sizes that has not been used yet, the procedure returns to Step S32. The procedure from Step S32 to Step S44 is repeated until judgment of a red-eye area has been made for all the blocks in all the block sizes. If a red-eye area has been detected in the procedure, the red-eye detection unit 26 sends a signal that represents occurrence of red eye to the update unit 28. In the case where no red-eye area has been detected, the red-eye detection unit 26 sends a signal that represents success of red-eye prevention to the update unit 28.

If flash photography is carried out after the procedure from Step S2 to Step S22 in FIG. 2 has been carried out for the first time, the procedure returns to Step S2 from Step S24 in FIG. 2. Assume that the procedure has returned to Step S2 in order to carry out flash photography for the second time. At this stage, the reference data stored in the memory 14 are as shown in FIG. 3B.

At Step S6 carried out second time after Steps S2 and S4, in the case where the identification unit 16 has judged that the characteristics of the face area of a target person identified at the immediately preceding Step S4 agree with the characteristics of the person A represented by the identification data that have been stored in the memory 14, the procedure goes to Step S12 after Step S8. Since additional registration at Step S10 is not carried out, the reference data in the memory 14 still represent the state shown by FIG. 3B. Therefore, the photography condition selection unit 20 at Step S12 selects the photography conditions for the person A in the reference data shown in FIG. 3B, that is, the conditions of 3-second pre-flash and 30 cm lens-flash distance, as the actual photography conditions for the flash photography this time, based on information from the identification unit 16 that the target person is the person A.

At the following Step S14, the condition representing the 3-second duration of pre-flash is sent from the photography condition selection unit 20 to the setting change unit 22 as a part of the actual photography conditions selected at Step S12, and the setting change unit 22 sends the setting change signal to the camera 12 for setting the duration of pre-flash to 3 seconds. Since the duration was 3 seconds in the flash photography last time, the previous setting is maintained although the setting change signal is actually sent. At Step S16, the condition representing the 30 cm lens-flash distance, which is different from the previous photography, is displayed on the display unit 24. The operator confirming a corresponding message displayed on the display unit 24 can change the distance to 30 cm prior to the flash photography this time.

At Step S18, the camera 12 carries out flash photography according to the actual photography conditions set in the above manner. Assume that the photograph image obtained at Step S18 this time is an image 32 shown in FIG. 3 and the red-eye detection unit 26 has detected occurrence of red eye again at Step S20. In this case, at Step S22, the update unit 28 changes the duration of pre-flash for the person A from 3 seconds to 5 seconds in the reference data so that tendency of red-eye occurrence is suppressed for the person A. Which of the conditions, that is, either the duration or the distance, needs to be changed by how much is determined according to predetermined priority of the change and predetermined stepwise ranges of the change.

Assume that the procedure has returned to Step S2 in FIG. 2 for flash photography for the third time, and the identification unit 16 at Step S6 has judged that the characteristics of the face area detected at the immediately preceding Step S4 do not agree with the registered characteristics of the person A. In this case, a target person is not identified, and the procedure goes from Step S8 to Step S10 in FIG. 2.

At Step S10, the identification unit 16 sends to the registration unit 18 the data representing the characteristics of the face area of the unidentified target person as the data of an additional person. The registration unit 18 registers the data of the additional person with the memory 14 as a part of the data for identification, and gives a label B to the additional person. The registration unit 18 combines the label B and the default photography conditions determined in advance as the initial photography conditions, and registers the combination as a part of the reference data for red-eye prevention with the memory 14. Therefore, the reference data stored in the memory 14 are as shown in FIG. 3C.

At Step S12, the photography condition selection unit 20 selects the conditions defined as the photography conditions for the person B in the reference data shown in FIG. 3C, that is, the conditions representing 3-second pre-flash and 20 cm lens-flash distance, as the actual photography conditions for the flash photography this time, based on information from the identification unit 16 that the target person is the person B.

At Step S14, the condition of 3-second pre-flash as a part of the actual photography conditions selected at Step S12 is sent from the photography condition selection unit 20 to the setting change unit 22. The setting change unit 22 sends the setting change signal to the camera 12 for changing the duration of pre-flash to 3 seconds. Since the duration was 3 second in the flash photography last time, the previous setting is maintained although the setting change signal is actually sent. At Step S16, the condition representing 20 cm lens-flash distance, which is different from the previous photography, is displayed on the display unit 24. The operator confirming a corresponding message displayed on the display unit 24 can change the distance to 20 cm prior to the flash photography this time.

At Step S18, the camera 12 carries out flash photography according to the actual photography conditions set in the above manner. Assume that the photograph image obtained at Step S18 this time is an image 34 shown in FIG. 3 and the red-eye detection unit 26 has not detected occurrence of red eye. In this case, the update unit 28 judges that red eye has been successfully prevented from occurring by the actual photography conditions used this time, and maintains the photography conditions for the person B defined by the reference data in the memory 14 without changing the conditions. Therefore, the reference data are maintained as shown in FIG. 3D, which are the same as FIG. 3C.

Assume that the procedure has returned to Step S2 in FIG. 2 for flash photography for the fourth time and the identification unit 16 has judged at Step S6 after Steps S2 and S4 that the characteristics of the face area of a target person identified at the immediately preceding Step S4 agree with the characteristics of the person A represented by the data for identification that have been stored in the memory 14. In this case, the procedure goes to Step S12 after Step S8. Since additional registration at Step S10 is not carried out, the reference data in the memory 14 still represent the state shown by FIG. 3D. Therefore, the photography condition selection unit 20 selects at Step S12 the photography conditions for the person A in the reference data shown in FIG. 3D, that is, the conditions of 5-second pre-flash and 30 cm lens-flash distance, as the actual photography conditions for the flash photography this time according to information from the identification unit 16 that the target person is the person A.

At Step S14, the condition representing the 5-second duration of pre-flash is sent from the photography condition selection unit 20 to the setting change unit 22 as a part of the actual photography conditions selected at Step S12, and the setting change unit 22 sends a setting change signal to the camera 12 for setting the duration of pre-flash to 5 seconds. At Step S16, the condition representing the 30 cm lens-flash distance, which is different from the previous photography, is displayed on the display unit 24. The operator confirming a corresponding message displayed on the display unit 24 can change the distance to 30 cm prior to the flash photography this time.

At Step S18, the camera 12 carries out flash photography according to the actual photography conditions set in the above manner. Assume that the photograph image obtained at Step S18 this time is an image 36 shown in FIG. 3 and the red-eye detection unit 26 has not detected occurrence of red eye. In this case, the update unit 28 judges that red eye has been successfully prevented from occurring by the actual photography conditions used in this time for the person A, and maintains the photography conditions for the person A defined by the reference data in the memory 14 without changing the conditions. Therefore, the reference data are maintained as shown in FIG. 3E, which are the same as FIG. 3D.

As the procedure from Step S2 to Step S24 is repeated in this manner, the reference data are accumulated in the memory 14 for defining the photography conditions for preventing red-eye occurrence for various people. In this manner, the actual photography conditions optimal for preventing red-eye occurrence can be selected and set at each time of flash photography, depending on a difference in tendency of red-eye occurrence among various people as target persons.

The red-eye prevention device 10 in the first embodiment has the red-eye detection unit 26 and the update unit 28 for updating the reference data so as to sequentially improve an effect of red-eye prevention based on presence or absence of red eye in actual photograph images obtained by flash photography and the actual photography conditions used at the time of flash photography. However, as long as the actual photography conditions can be selected according to a target person by using the reference data defining the photography conditions for each person, a configuration without updating may be adopted.

The red-eye prevention device 10 in the first embodiment may further comprise a photography situation detection unit for detecting a photography distance between a target person and the camera 12 and/or lightness of a photography environment. In this case, the photography conditions defined by the reference data in the memory 14 for each person may be photography conditions defined according to the photography distance and/or the lightness so that the actual photography conditions can be selected according to the target person and the photography distance and/or the lightness. The reference data in this case may be represented as a reference table defining the photography conditions for each person and for the photography distance and/or the lightness at predetermined intervals. Alternatively, the reference data may define the photography conditions as a function of the photography distance and/or the lightness for each person.

In the red-eye prevention device 10 in the first embodiment, the identification unit 16 identifies a target person by using the data for identification stored in the memory 14. However, manual specification of a target person who is subjected to flash photography may be received. In addition, the registration unit 18 may receive manual registration of a target person and the photography conditions therefor. Alternatively, the registration unit 18 may receive manual registration of only a target person and registers the default photography conditions as the initial photography conditions for each person, for example. In this case, the red-eye detection unit 26 and the update unit 28 serially updates the photography conditions for each person.

Only the setting change unit 22 or the display unit 24 may be used. Furthermore, although the condition on the duration of pre-flash is sent to the setting change unit 22 while the condition on the lens-flash distance is sent to the display unit 24 in the first embodiment, the conditions sent to the setting change unit 22 and the display unit 24 may overlap.

The case has been described above where the number of target persons included in a photograph image is 1, as shown in FIG. 3. However, the identification unit 16 may be able to identify a plurality of target persons. In this case, the photography condition selection unit 20 selects the actual photography conditions for red-eye prevention for all the target persons identified by the identification unit 16, based on the reference data. For example, in the case where the reference data shown by FIG. 3E are stored in the memory 14 and a photograph image of the persons A and B is going to be photographed, the identification unit 16 identifies the persons A and B. The photography condition selection unit 20 can select the photography conditions for the person A, that is, the 5-second duration of pre-flash and the 30 cm distance between the lens and the flash, as the actual photography conditions that cause less red-eye occurrence, for example.

The procedure shown in FIG. 2 is for flash photography. However, in the case where the camera 12 has set to an automatic flash mode, the red-eye prevention device 10 may carry out the procedure shown in FIG. 2 only if a photography environment is darker than a predetermined threshold.

Although the red-eye prevention device 10 in the first embodiment is installed in the camera 12 by being connected thereto, all or a part of the red-eye prevention device 10 shown in FIG. 1 may be built in the camera 12.

Although the red-eye prevention device 10 in the first embodiment of the present invention has been described above, a program for causing a computer installable in a camera to function as means corresponding to the identification unit 16, the registration unit 18, the photography condition selection unit 20, the setting change unit 22, the display unit 24, the red-eye detection unit 26, and the update unit 28 for carrying out the red-eye prevention processing is another embodiment of the present invention. In addition, a computer-readable recording medium storing the program is another embodiment of the present invention. Various modifications can be made to the program and the recording medium. For example, the procedure for causing the computer to function as the means corresponding to the red-eye detection unit 26 and the update unit 28 may be omitted.

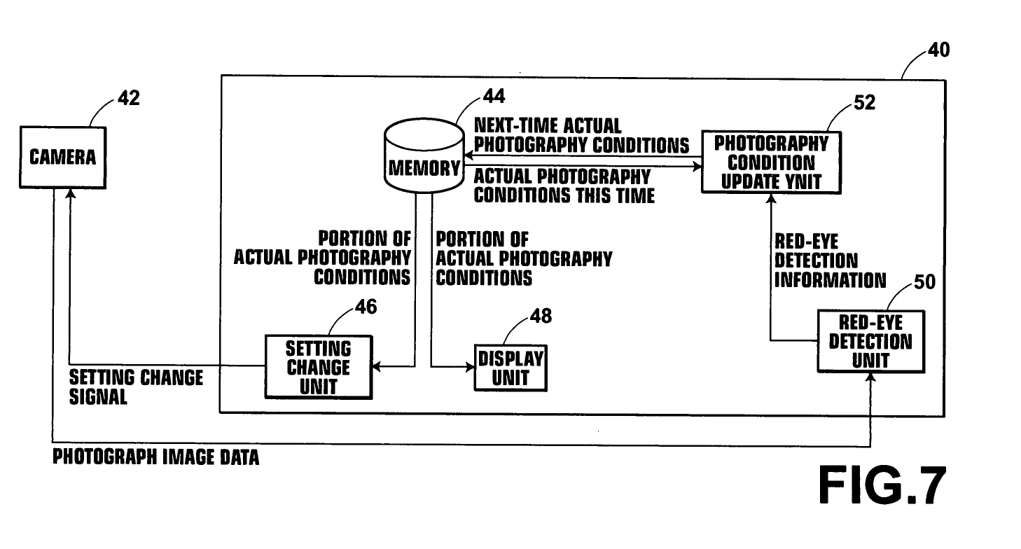

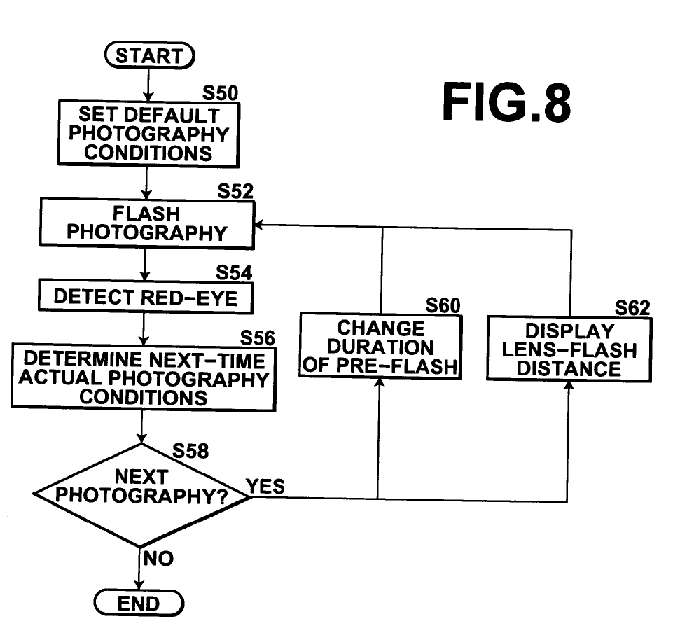

A red-eye prevention device of a second embodiment of the present invention will be described next with reference to FIGS. 7 and 8.

FIG. 7 is a block diagram showing the configuration of a red-eye prevention device 40 of the second embodiment. The red-eye prevention device 40 is installed in a camera 42 by being connected thereto, and comprises a memory 44, a setting change unit 46, a display unit 48, a red-eye detection unit 50, and a photography condition update unit 52. The memory 44 stores photography conditions for red-eye prevention, and stores default photography conditions representing 3-second pre-flash duration and 20 cm distance between a lens and a flash in an initial state thereof.

The camera 42 is also a digital camera enabling adjustment of the distance between the camera and the flash by an extendable arm.

A procedure of flash photography including red-eye prevention processing carried out by the camera 42 and the red-eye prevention device 40 shown in FIG. 7 will be described in detail with reference to a flow chart shown in FIG. 8.

At Step S50, the default photography conditions stored in the memory 44 are set as actual photography conditions used in flash photography for the first time. More specifically, the setting change unit 46 obtains the condition of 3-second pre-flash as a part of the default photography conditions stored in the memory 44, and the setting change unit 46 sends a setting change signal to the camera 42 for setting duration of pre-flash to 3 seconds. At the same time, the display unit 48 obtains the condition of 20 cm lens-flash distance, and displays the condition for confirmation by an operator. The operator confirming a message representing the condition can adjust the distance between the lens and the flash to 20 cm by adjusting the arm connecting the camera and the flash prior to flash photography.

At Step S52, the camera 42 carries out flash photography by using the actual photography conditions that have been set. Photograph image data obtained by the photography are stored in a memory of the camera 42 and sent to the red-eye detection unit 50 of the red-eye prevention device 40.

At Step S54, the red-eye detection unit 50 detects whether or not red eye is observed in the image represented by the photograph image data sent from the camera 42. A method adopted by the red-eye detection unit 50 may be the method shown by FIG. 6 or any other method.

At Step S56, the photography condition update unit 52 determines next-time actual photography conditions to be used for photography next time, based on information representing presence or absence of red eye sent from the red-eye detection unit 50 and the actual photography conditions used this time and stored in the memory 44. More specifically, in the case where the red-eye detection unit 50 has detected occurrence of red eye, the photography condition update unit 52 sets the next-time actual photography conditions that cause less red-eye occurrence than the actual photography conditions used this time by increasing the lens-flash distance by 10 cm, for example. The next-time actual photography conditions of 3-second pre-flash and 30 cm lens-flash distance are therefore set. In the case where red eye has not been detected by the red-eye detection unit 50, the photography condition update unit 52 sets the actual photography conditions used this time as the next-time actual photography conditions. Alternatively, since red eye can be prevented by using shorter duration and/or a shorter distance, the photography condition update unit 52 may set the next-time actual photography conditions generally causing more red eye, such as 2-second pre-flash and 20 cm lens-flash distance by shortening the duration by 1 second, for example.

In the case where flash photography is carried out next time after the procedure from Step S52 to Step S56 has been completed, the procedure in FIG. 7 goes from Step S58 to Step S60 and to Step S62. At Step S60, the setting change unit 46 obtains the condition on the duration out of the next-time actual photography conditions stored in the memory 44, and sends a setting change signal to the camera 42 for setting the duration of pre-flash to the duration defined by the corresponding next-time actual photography condition. In addition, at Step S62, the display unit 48 obtains the condition on the lens-flash distance out of the next-time actual photography conditions, and displays a message corresponding to the condition for confirmation by the operator of the camera 42. The operator confirming the message adjusts the arm connecting the camera and the flash prior to the subsequent flash photography, and changes the distance according to the displayed distance. Thereafter, the camera 42 carries out flash photography by using the next-time photography conditions at Step S52 for the second time.

By repeating the procedure from Step S52 to Step S62 in the above manner, the actual photography conditions for prevention of red-eye occurrence with less burden on a target person and the camera can be found by improving a probability of red-eye prevention in a stepwise manner and by shortening duration of pre-flash as much as possible in a range that can prevent red-eye occurrence in an actual photography situation, according to tendency of red-eye occurrence caused by a combination of various factors in actual photography.

The red-eye prevention device 40 in the second embodiment determines the next-time actual photography conditions, based on presence or absence of red eye and the actual photography conditions used at the time of immediately preceding flash photography. However, the next-time actual photography conditions may be determined based on the actual photography conditions used in the immediately preceding flash photography and in flash photography prior thereto.

Only the setting change unit 46 or the display unit 48 may be used alone. Furthermore, although the condition on the duration of pre-flash is sent to the setting change unit 46 while the condition on the lens-flash distance is sent to the display unit 48 in the second embodiment, the conditions sent to the setting change unit 46 and the display unit 48 may overlap.

The procedure shown in FIG. 8 is for flash photography. However, in the case where the camera 42 has been set to an automatic flash mode, the red-eye prevention device 40 may carry out the procedure shown in FIG. 8 only if a photography environment is darker than a predetermined threshold.

Although the red-eye prevention device 40 in the second embodiment is installed in the camera 42 by being connected thereto, all or a part of the red-eye prevention device 40 shown in FIG. 7 may be built in the camera 42.

Although the red-eye prevention device 40 in the second embodiment of the present invention has been described above, a program for causing a computer installable in a camera to function as means corresponding to the setting change unit 46, the display unit 48, the red-eye detection unit 50, and the photography condition update unit 52 for carrying out the red-eye prevention processing is another embodiment of the present invention. Furthermore, a computer-readable recording medium storing the program is another embodiment of the present invention. Various modifications can be made to the program and the recording medium.

The preferred embodiments of the invention described above in detail are merely examples, and it is intended that the appended claims cover the true spirit and scope of the present invention.

1. A red-eye prevention device installable in a camera and comprising:
registration means for registering a plurality of persons and photography conditions for the respective persons as reference data for red-eye prevention;
identification means for identifying a target person to be subjected to flash photography by the camera; and
photography condition selection means for selecting actual photography conditions for preventing red eye at the time of actual flash photography of the target person identified by the identification means with the camera, based on the reference data.

2. The red-eye prevention device according to claim 1 further comprising display means for displaying the content of all or a part of the actual photography conditions so that an operator can confirm the content.

3. The red-eye prevention device according to claim 1 further comprising setting change means for changing a setting of the camera so as to satisfy all or a part of the actual photography conditions.

4. The red-eye prevention device according to claim 1 further comprising:
red-eye detection means for detecting whether or not red eye is observed regarding the target person in a photograph image generated by the actual flash photography by the camera using the actual photography conditions; and
update means for updating the photography conditions for the target person in the reference data, based on presence or absence of red eye and the actual photography conditions.

5. The red-eye prevention device according to claim 4, wherein the registration means registers default photography conditions determined in advance, as initial photography conditions for an additional person at the time of registration of the additional person.

6. The red-eye prevention device according to claim 1 further comprising:
photography situation detection means for detecting a distance between the target person and the camera and/or lightness of a photography environment, wherein
the photography conditions defined by the reference data for each of the persons are photography conditions defined according to the distance between the camera and the corresponding person and/or the lightness of the photography environment.

7. The red-eye prevention device according to claim 6 further comprising:
red-eye detection means for detecting whether or not red eye is observed regarding the target person in a photograph image generated by the actual flash photography of the target person by the camera using the actual photography conditions; and
update means for updating the photography conditions for the target person in the reference data, based on presence or absence of red eye, the distance and/or the lightness detected by the photography situation detection means, and the actual photography conditions.

8. The red-eye prevention device according to claim 7, wherein the registration means registers default photography conditions determined in advance, as initial photography conditions for an additional person at the time of registration of the additional person.

9. The red-eye prevention device according to claim 1, wherein the identification means is able to identify a plurality of target persons at the same time and
the photography condition selection means selects the actual photography conditions for prevention of red eye for all the target persons identified by the identification means, based on the reference data.

10. The red-eye prevention device according to claim 4, wherein the identification means is able to identify a plurality of target persons at the same time and
the photography condition selection means selects the actual photography conditions for prevention of red eye for all the target persons identified by the identification means, based on the reference data.

11. The red-eye prevention device according to claim 6, wherein the identification means is able to identify a plurality of target persons at the same time and
the photography condition selection means selects the actual photography conditions for prevention of red eye for all the target persons identified by the identification means, based on the reference data.

12. The red-eye prevention device according to claim 7, wherein the identification means is able to identify a plurality of target persons at the same time and
the photography condition selection means selects the actual photography conditions for prevention of red eye for all the target persons identified by the identification means, based on the reference data.

13. The red-eye prevention device according to claim 1, wherein the photography conditions include a distance between an imaging lens and a flash of the camera.

14. The red-eye prevention device according to claim 4, wherein the photography conditions include a distance between an imaging lens and a flash of the camera.

15. The red-eye prevention device according to claim 6, wherein the photography conditions include a distance between an imaging lens and a flash of the camera.

16. The red-eye prevention device according to claim 7, wherein the photography conditions include a distance between an imaging lens and a flash of the camera.

17. The red-eye prevention device according to claim 1, wherein the photography conditions include a condition representing an amount of light in pre-flash.

18. The red-eye prevention device according to claim 4, wherein the photography conditions include a condition representing an amount of light in pre-flash.

19. The red-eye prevention device according to claim 6, wherein the photography conditions include a condition representing an amount of light in pre-flash.

20. The red-eye prevention device according to claim 7, wherein the photography conditions include a condition representing an amount of light in pre-flash.

21. A red-eye prevention device installable in a camera and comprising:
red-eye detection means for detecting whether or not red eye is observed in a photograph image obtained by flash photography by the camera using predetermined actual photography conditions; and
photography condition update means for determining next-time actual photography conditions for preventing occurrence of red eye in flash photography next time, based on presence or absence of red eye and the predetermined actual photography conditions.

22. The red-eye prevention device according to claim 21 further comprising display means for displaying the content of all or a part of the next-time actual photography conditions so that an operator can confirm the content.

23. The red-eye prevention device according to claim 21 further comprising setting change means for changing a setting of the camera so as to satisfy all or a part of the next-time actual photography conditions.

24. The red-eye prevention device according to claim 21, wherein the predetermined actual photography conditions and the next-time actual photography conditions include a distance between an imaging lens and a flash of the camera.

25. The red-eye prevention device according to claim 21, wherein the predetermined actual photography conditions and the next-time actual photography conditions include a condition representing an amount of light in pre-flash.

26. The red-eye prevention device according to claim 25, wherein the predetermined actual photography conditions and the next-time actual photography conditions include a condition representing an amount of light in pre-flash.

27. A red-eye prevention program for causing a computer installable in a camera to function as:
registration means for registering a plurality of persons and photography conditions for the respective persons as reference data for red-eye prevention;
identification means for identifying a target person to be subjected to flash photography by the camera; and
photography condition selection means for selecting actual photography conditions for preventing red eye at the time of actual flash photography of the target person identified by the identification means with the camera, based on the reference data.

28. A red-eye prevention program for causing a computer installable in a camera to function as:
red-eye detection means for detecting whether or not red eye is observed in a photograph image obtained by flash photography by the camera using predetermined actual photography conditions; and
photography condition update means for determining next-time actual photography conditions for preventing occurrence of red eye in flash photography next time, based on presence or absence of red eye and the predetermined actual photography conditions.

29. A computer-readable recording medium storing a red-eye prevention program for causing a computer installable in a camera to function as:
registration means for registering a plurality of persons and photography conditions for the respective persons as reference data for red-eye prevention;
identification means for identifying a target person to be subjected to flash photography by the camera; and
photography condition selection means for selecting actual photography conditions for preventing red eye at the time of actual flash photography of the target person identified by the identification means with the camera, based on the reference data.

30. A computer-readable recording medium storing a red-eye prevention program for causing a computer installable in a camera to function as:
red-eye detection means for detecting whether or not red eye is observed in a photograph image obtained by flash photography by the camera using predetermined actual photography conditions; and
photography condition update means for determining next-time actual photography conditions for preventing occurrence of red eye in flash photography next time, based on presence or absence of red eye and the predetermined actual photography conditions.
